(19) United States
(12) Patent Application Publication
(10) Pub. No.: US 2013/0146620 A1
(43) Pub. Date: Jun. 13, 2013

(54) SHOTGUN WATER BOTTLE

(71) Applicant: Faramarz H. Ghezelayagh, Irvine, CA (US)

(72) Inventor: Faramarz H. Ghezelayagh, Irvine, CA (US)

(21) Appl. No.: 13/313,411

(22) Filed: Dec. 7, 2011

(51) Int. Cl. B67D 3/00

(52) U.S. Cl. 222/482

(57) ABSTRACT

A water bottle and method of hydration is disclosed. The water bottle has a first and second port for dispensing a liquid. For normal hydration the first port is used, but when rapid hydration is desired, the second port is opened and used in conjunction with the first port to increase fluid flow.

### FIELD

This invention relates generally to a water bottle, and in particular, to a sports bottle with a primary and secondary means of fluid flow for increased liquid flow rate.

### BACKGROUND

Proper hydration is important while performing cardiovascular exercise. To maintain a proper level of hydration, athletes generally carry a portable container of liquid such as a water bottle. Water bottles come in many sizes, shapes, and materials. Some are made to carry a large amount of water for extended excursions such as a camping trip or a hike. Others may be specially formed to distribute weight across the body much like a backpack. Still others may be made to carry only a few ounces and attach to a runner's belt. The materials that can be made into water bottles are as varied as the bottles themselves. The most common water bottles are made of plastic, aluminum, and stainless steel.

Plastic water bottles are common because they are inexpensive to produce. The disposable water bottles commonly found at grocery stores and discount warehouse stores are generally polyethylene terephthalate (PET) bottles. These bottles are made to be disposable. They are generally made with less plastic to save cost and to be more environmentally friendly. A drawback of the common disposable plastic water bottle is a tendency to leach carcinogens such as Bis(2-ethylhexyl)phthalate, commonly abbreviated as DEHP or an estrogenic such as Bisphenol A (BPA), from the plastic into the liquid stored in the bottle.

Another popular material for making water bottles is aluminum. Aluminum water bottles may be preferred over plastic water bottles because they are more durable and do not contain DEHP and BPA. However, aluminum can also leach into the liquid, especially if the liquid is acidic. Drinks such as lemonade may cause excessive amounts of aluminum to leach into the drink. To keep undesirable amounts of aluminum out of the liquid, a bottle liner is often used with the aluminum bottle. Unfortunately, the bottle liner may have some of the same problems as a PET plastic bottle, namely, leaching of BPA and DEHP into the liquid contents.

One type of special purpose water bottle is the sports bottle. Sport bottles are aptly named as they are generally used during or after physical activity, such as participation in a sporting event. Sports bottles also run the gamut of materials and sizes but are generally cylindrical and light enough to be carried with one hand. Another feature of the sports bottle is a unitary cap. The sports bottle caps or sport caps feature a base which screws into the threads on a water bottle. The sport cap also features a slideable top with an opening in the top. The opening is sealed by a plug which slides into and out of the opening depending on the position of the top. The unitary cap allows sport bottles to be opened and closed using one hand. Also the unitary design of the cap prevents the sport cap from being dropped or misplaced during physical activity.

A problem experienced by dehydrated athletes using a conventional water bottle is the low volume of liquid that conventional water bottles are capable of dispensing. As liquid flows from the water bottle an equal volume of air must enter the water bottle otherwise a vacuum forms. In a conventional water bottle, air flow into the water bottle is restricted because there is only one opening in the sports bottle. Air and liquid must flow through the same opening in opposite directions. The single opening limits the influx of air, causing a vacuum to form in the water bottle. A vacuum will inhibit the flow of liquid pouring out of the water bottle. The vacuum negative pressure increases until air is drawn through the opening to equalize the pressure. A conventional water bottle only has one opening, thus both the out flowing liquid and the inflowing air has to use the same opening in the water bottle. As a result the outflow of liquid is impeded when air is drawn through the single opening. Instead of a solid stream of liquid continuously pouring forth, the stream from a conventional water bottle is intermittently interrupted by the inrushing of air through the single opening.

Water bottles with sport caps, also known as sports bottles are even more restricted in their ability to dispense liquids. The sport caps are convenient to open on the run, needing only the use of one hand. However, because of their design, the opening in the sport cap is even smaller than the opening in a conventional water bottle. The smaller opening in a sport cap restricts the flow of liquid out of a sports bottle even more so than a conventional water bottle.

Water bottles may also be squeezed to dispense a stream of liquid. However, squeezing is not a perfect solution. Disposable PET plastic water bottles may be damaged if excessive force is used to squeeze the bottle. Aluminum, rigid plastic, or stainless steel water bottles would resist deformation thus squeezing them is not a viable option.

There exists a need for a water bottle that can dispense a high volume of liquid in a short amount of time without deforming the bottle.

### SUMMARY

An aspect of the invention generally relates to a container for carrying liquid and more specifically to a water bottle with two or more openings to allow a higher volumetric flow rate from the water bottle. In normal use the first opening dispenses liquid in a similar manner to conventional water bottles. If a higher flow rate is desired, the bottle is held in an upright position, and the second opening is unsealed. When the first opening is subsequently opened, a greater volume of liquid will be released.

### BRIEF DESCRIPTION OF THE DRAWINGS

FIG. 1 illustrates an exemplary water bottle with a sport cap and secondary means of fluid flow in accordance with an aspect of the disclosure.

FIG. 1A illustrates a magnified view of the secondary means of fluid flow of FIG. 1.

FIG. 2 illustrates another exemplary water bottle with a sport cap and secondary means of fluid flow in accordance with another aspect of the disclosure.

FIG. 2A illustrates a magnified view of the secondary means of fluid flow of FIG. 2.

FIG. 3 illustrates another exemplary water bottle with a pluggable secondary means of fluid flow in accordance with another aspect of the disclosure.

FIG. 3A illustrates a magnified view of the plug of FIG. 3 from a different perspective.

FIG. 4 illustrates another exemplary water bottle with a collapsible spout in accordance with another aspect of the disclosure.

FIG. 4A illustrates a magnified view of the secondary means of fluid flow of FIG. 4 from a different perspective.

FIG. 5 illustrates another exemplary water bottle with a secondary means of fluid flow sealed by a foil seal in accordance with another aspect of the disclosure.

FIG. 5A illustrates a magnified view of the foil seal of FIG. 5

### DETAILED DESCRIPTION OF THE EXEMPLARY EMBODIMENTS

In the following detailed description of the embodiments of the invention, numerous specific details are set forth in order to provide a thorough understanding of the present invention. However, it will be obvious to one skilled in the art that the embodiments of the invention may be practiced without these specific details. In other instances well known methods, procedures, and components have not been described in detail so as not to unnecessarily obscure aspects of the embodiments of the invention.

In accordance with one aspect of the present invention, a water bottle with a housing adapted to contain a liquid is described herein. A first port and a second port are coupled to the housing. In an upright position, the first port may be located at the top of the bottle and the second port may be located at the bottom of the bottle. A removable cap may be coupled to each of the first and second ports.

In accordance with another aspect of the present invention, one or both of the first and second ports may be capped with a screw cap or a plug. The screw cap screws onto threads formed on the water bottle. For the first port, the threads are located on the neck of the water bottle. For the second port the thread may be located at the distal end of a spout, coupled to the base of the bottle.

In accordance with another aspect of the present invention, one or both of the first port and second ports may be capped with a variable flow cap. The variable flow cap may be a sport cap. The variable flow cap may be used to directly or indirectly vary the fluid flow rate from the water bottle. For example, a sport cap, capping the first port, limits the fluid flow rate directly out of the first port by adjusting the size of the opening in the first port. Alternatively, by varying the amount of air flow into the first port, a sport cap on the first port may also indirectly control the fluid flow rate of the second port.

The water bottle as described in this applications is a portable container for liquid. Although the portable container is referred to as a “water bottle”, it should be known that any drinkable liquid may be contained therein.

In accordance with another aspect of the present invention, a method of drinking from a water bottle is described herein. While holding the bottle upright, the lower port also referred to as the second port is opened by removing the removable cap or seal on the second port. To increase the liquid flow rate, the higher port, a.k.a. the first port, may be opened.

As previously discussed, plastic is a preferred material for the manufacturing of water bottles because plastic is light, sanitary, economical, and can be molded into a variety of shapes. Plastic can also be made opaque or translucent and is available in many custom colors.

Some of the problems with plastic water bottles have been discussed above. These problems include leaching of carcinogens and estrogenics into the contents of the bottle. It is thus preferable to manufacture the exemplary water bottle using a PET plastic that is DEPH and BPA free to avoid causing health problems to the consumer. DEHP and BPA free PET plastics are commercially available and the manufacturing of said plastic need not be discussed within this specification.

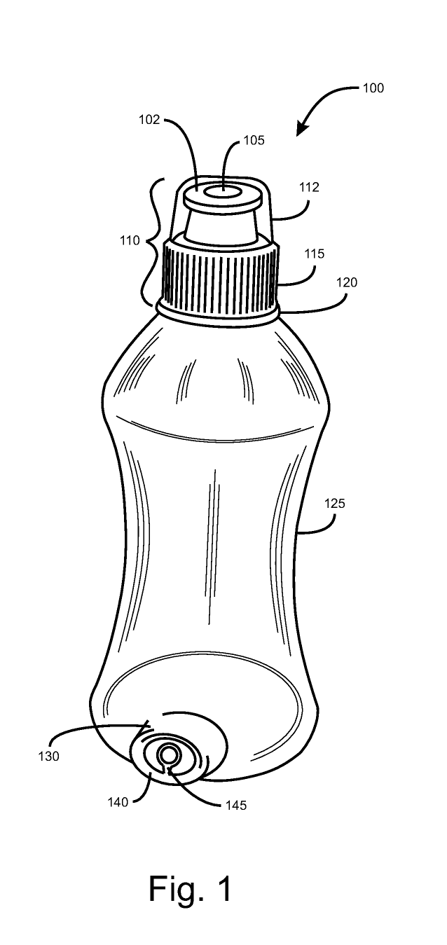

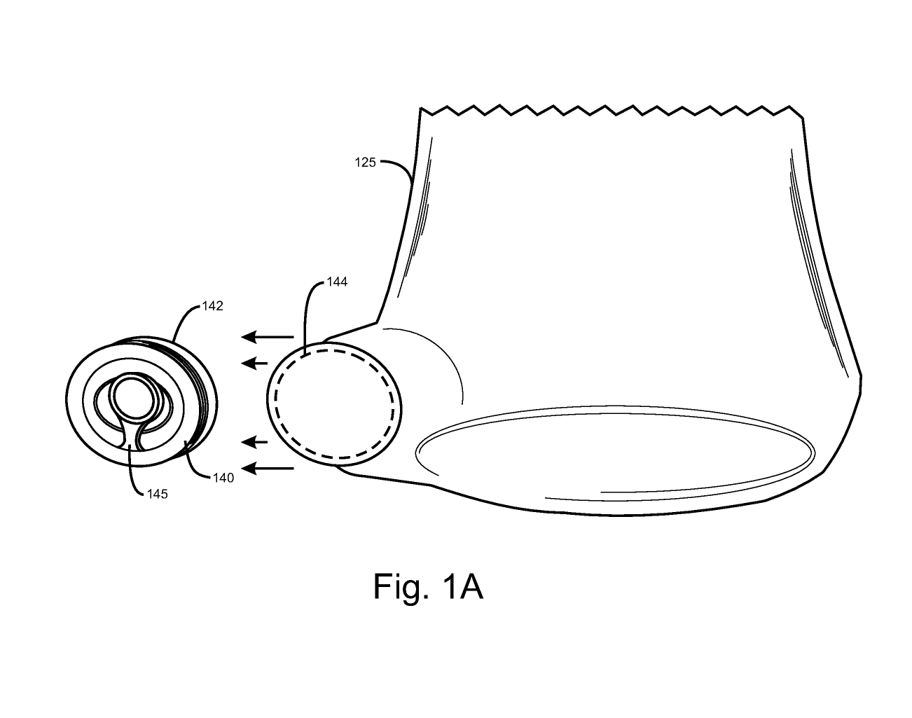

FIG. 1 illustrates an exemplary water bottle in accordance with an aspect of the disclosure. The exemplary water bottle may be made of a PET plastic that is DEHP and BPA free. The exemplary water bottle depicted has a top region including a sport cap, capping a first means of fluid flow, a contoured middle region, and a bottom region containing a secondary means for fluid flow.

The exemplary water bottle 100 illustrated in FIG. 1 is designed to contain and dispense liquids. The top of the exemplary water bottle 100 may include a first means of fluid flow, also referred to as a first opening or first port 105 to dispense liquid. The first port 105 may be an opening in a sport cap 110. The middle region 125 of water bottle 100 may be slightly concave to provide a secure gripping area. Below middle region 125 is a bottom region with a flat bottom to provide a stable base when bottle 100 is placed on a flat surface. The bottom region may include a secondary means of fluid flow 130.

Also known as a sports top, the sport cap 110 may couple to the top of the water bottle by screwing onto threads on the water bottle. Sport cap 110 is designed to seal first port 105. Sport cap 110 generally includes a plastic nipple 102 which is slidingly coupled to sport cap 110. The plastic nipple 102 may be pulled upwards to open the sport cap and pushed downwards to close the sport cap. The unitary design of sport cap 110 allows the water bottle to be operated with one hand. The consumer may be in motion, such as while running or cycling and still operate sport cap 110.

Sport cap 110 may also have a hygienic shield 112, friction fitted to the sport cap 110. When snapped onto sport cap 110, the hygienic shield 112 forms a barrier around nipple 102, preventing germs from contaminating the water bottle 100. During normal usage, the hygienic shield 112 is removed from the top of water bottle 100. Hygienic shield 112 may be saved for later reuse should the consumer not finish the contents of water bottle 112 during one use.

After hygienic shield 112 is removed, the nipple 102 may be lifted exposing first opening 105. A consumer may then tilt the water bottle 100 back and drink from the sport cap. Liquid may be allowed to flow freely with the impetus of gravity or water bottle 100 may be given a slight squeeze to encourage fluid flow if the water bottle 100 is made of a deformable material.

Alternatively, the sport cap 110 may be removed by rotating the base of the sport cap 110 in a counterclockwise manner. Once the sport cap 110 is removed, liquid may be consumed directly from the neck of the water bottle 100. To aid in screwing and unscrewing the sport cap 110 from the water bottle 100, vertical ribs 115 may be formed on the base of sport cap 110. Below vertical ribs 115, water bottle 100 may include a safety ring 120. Safety ring 120 may be weakly coupled to sport cap 110. Unscrewing sport cap 110 from water bottle 100 may break the coupling giving a visual indicator that the bottle has been previously opened.

As previously mentioned, conventional water bottles have a problem dispensing liquids in a continuous stream. The intermittent influx of air prevents a consistent volume of liquid from being dispensed. After a sporting event an athlete may find it desirable to hydrate as rapidly as possible. A rapid stream or burst of cool liquid has been known to revitalize a fatigued body. To this end, embodiments of the invention are adapted with a secondary means of fluid flow to shotgun a burst of liquid.

To satisfy the need for rapid hydration an embodiment of the invention provides a secondary means of fluid flow. A spout 130, sealed by disposable cap 140 is located at the bottom of water bottle 100. The spout 130 may slightly protrude from water bottle 100. In this exemplary embodiment, spout 130 is unitarily molded from the body of water bottle 100. In other embodiments spout 130 may be a separate piece connected to water bottle 100.

Spout 130 may be sealed by disposable cap 140. Disposable cap 140 may also include a pull tab 145. The pull tab 145 provides a convenient finger hold to pull disposable cap 140 from water bottle 100 to unseal the secondary means of fluid flow. In some embodiments disposable cap 140 may seal spout 130 in such a manner as to break off when pressure is applied to disposable cap 140.

One method of sealing spout 130 may utilize a disposable cap 140 with a scored backing. The very edge of the backing may be heat bonded to spout 130 or permanently affixed with a strong adhesive. A circular portion just inside the very edge of the backing may be scored to allow spout 130 to be opened. The disposable cap 140 would remain sealed until the pull tab 145 is pulled outward from the bottle. Sufficient pressure on pull tab 145 will break the scored backing, removing disposable cap 140 and releasing the seal on the secondary means of fluid flow. Once spout 130 is unsealed, opening first port 105 will cause a shotgun hydration effect.

### Shotgun Hydration

To increase the flow rate of liquid dispensed through spout 130, a consumer can open spout 130, place the spout 130 in their mouth, open first port 105, and apply a slight suction to spout 130. The liquid being displaced would normally cause a vacuum and reduce flow rate out of spout 130. However, with first port 105 open to the atmosphere, an influx of air will balance out the vacuum or negative pressure, returning the inside of the bottle to a neutral pressure environment. Neutral pressure inside the bottle may allow more liquid to pass through spout 130 in a given amount of time.

Suction applied to spout 130 may increase the flow rate through the spout 130. Similarly, positive pressure created by squeezing the side of the bottle may also increase the flow rate. Varying the amount of air flow into the first port 105 may also vary the fluid flow rate of the second port 130. A wider open first port, allowing the influx of more air will cause a commensurate effect on the second port 130, e.g. causing a greater fluid flow rate out of the second port 130.

An advantage of the shotgun hydration method is being able to hydrate comfortably and safely. With the bottle in an upright position, no head craning is required to completely drain the bottle of its liquid contents. The upright position of the water bottle 100 also allows a better field of view during hydration. During normal usage of a prior art water bottle, a consumer's head is craned and the field of view is elevated. In contrast, the upright position of the water bottle 100 during shotgun hydration allows a forward field of view. It may be advantageous during exercise, for example cycling or running, to be able to see where one is going. The upright shotgun hydration method permits a cyclist or runner to see oncoming traffic and obstacles while hydrating.

FIG. 1A, illustrates a magnified view of the secondary means of fluid flow shown in FIG. 1, from a slightly different perspective. As described in FIG. 1, spout 130 slightly protrudes from the bottom region 128 of water bottle 100. Although the embodiment shown has a protruding spout, the invention should not be considered limited to a water bottle with a protruding spout unless so claimed. It may be easier for a consumer to drink from a protruding spout instead of the smooth sides of a water bottle. However, disposable cap 140 could conceivably be affixed directly to the side of water bottle 100 without an intermediary spout.

In FIG. 1A a disposable cap 140 is shown after removal from spout 130. Pull tab 145 may be used to separate disposable cap 140 from spout 130. Pulling on pull tab 145 in a direction away from the distal end of spout 130 may cause scored edge 142 to separate from scored lip 144. Once the scored backing of the disposable cap is broken, spout 130 is unsealed and the secondary means of fluid flow is open.

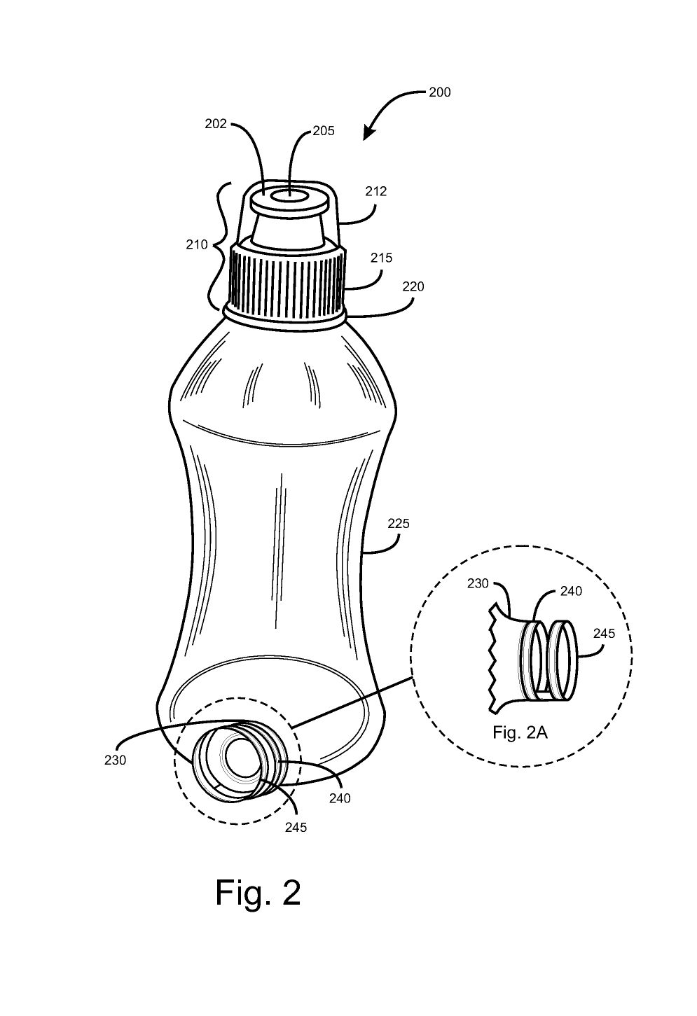

FIG. 2 illustrates a perspective view of water bottle 200 in accordance with another aspect of the disclosure. For the sake of clarity, analogous structures referenced in FIG. 1 will have similar reference numbers in FIG. 2. For example, hygienic shield 112 in FIG. 1 is hygienic shield 212 in FIG. 2.

One of the differences between FIG. 1 and FIG. 2 is the structure of the disposable cap 240 of FIG. 2. Disposable cap 240 lacks the pull tab 145 of FIG. 1. Instead, disposable cap 240 has a split ring structure 245 which serves a similar purpose. Split ring 245 may be pulled out from the body of water bottle 200 to separate the disposable cap 240 from water bottle 200.

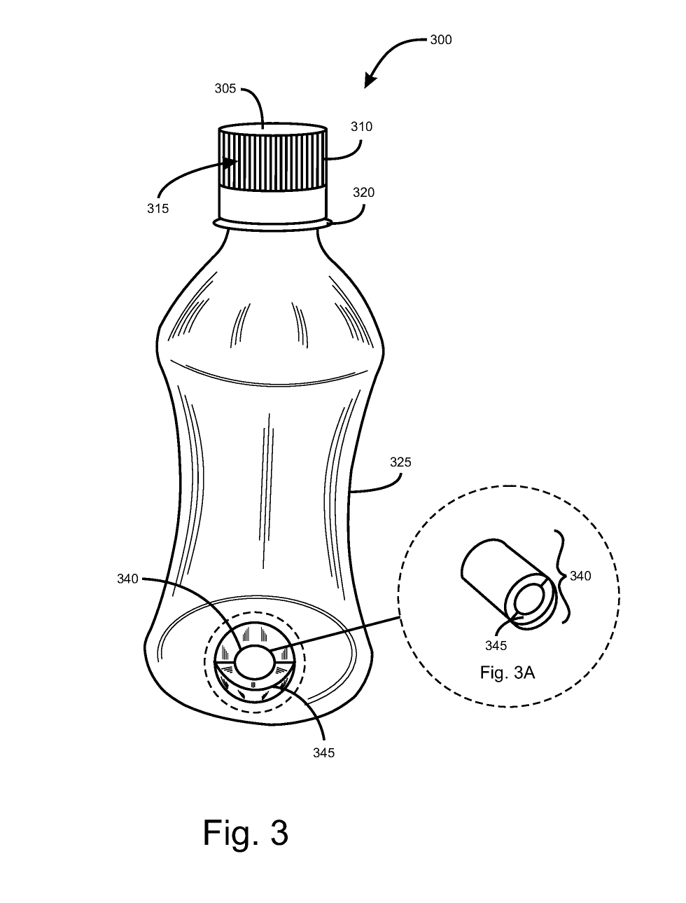

FIG. 3 depicts another exemplary water bottle with a removable plug in accordance with another aspect of the disclosure. The exemplary water bottle 300 includes a first port 305 (not shown) located at the top of water bottle 300 for dispensing a liquid. The first port 305 is sealed by screw cap 310 coupled to the neck of water bottle 300. Screw cap 310 may be coupled to water bottle 300 by threads formed at the neck of water bottle 300. Screw cap 310 removeably seals first port 305 when screw cap 310 is screwed onto water bottle 300. To open water bottle 300, screw cap 310 is rotated counterclockwise until screw cap 310 is uncoupled from the threads at the neck of water bottle 300. Conversely, to close the water bottle screw cap 310 is rotated clockwise until screw cap 310 seals first opening 305. Vertical ribs 315 may be formed around the periphery of screw cap 310. The ribs 315 form a non-slip surface that may aid in rotating screw cap 310.

Ring 320 may be formed at the neck of water bottle 300, directly below screw cap 310. Ring 320 may be a unitary ring formed of the same material as water bottle 300 with a flat horizontal surface adjacent to screw cap 310. When closed, the bottom of screw cap 310 may rest upon the horizontal surface of ring 320 forming a water tight seal. Ring 320 may also be useful for lifting water bottle 300 during the bottling process. Ring 320 may alternatively be a safety feature. Ring 320 may be weakly coupled to sport cap 310. Unscrewing sport cap 310 from water bottle 300 may break the coupling giving a visual indicator that the bottle has been previously opened.

As disclosed above, water bottle 300 may be formed of a plurality of materials. The water bottle 300 depicted in FIG. 3 is formed of a PET plastic and may be BPA and DEHP free, however the invention is not limited to such. Other materials such as aluminum or stainless steel may also be used.

Water bottle 300 also includes a secondary means of fluid flow. At the bottom of water bottle 300, is a spout 330 (not shown), slightly protruding from the body of the water bottle 300. Spout 330 is sealed by a plastic plug 340 with handle 345. Plastic plug 340 is friction fitted to seal spout 330, but may also be glued in place.

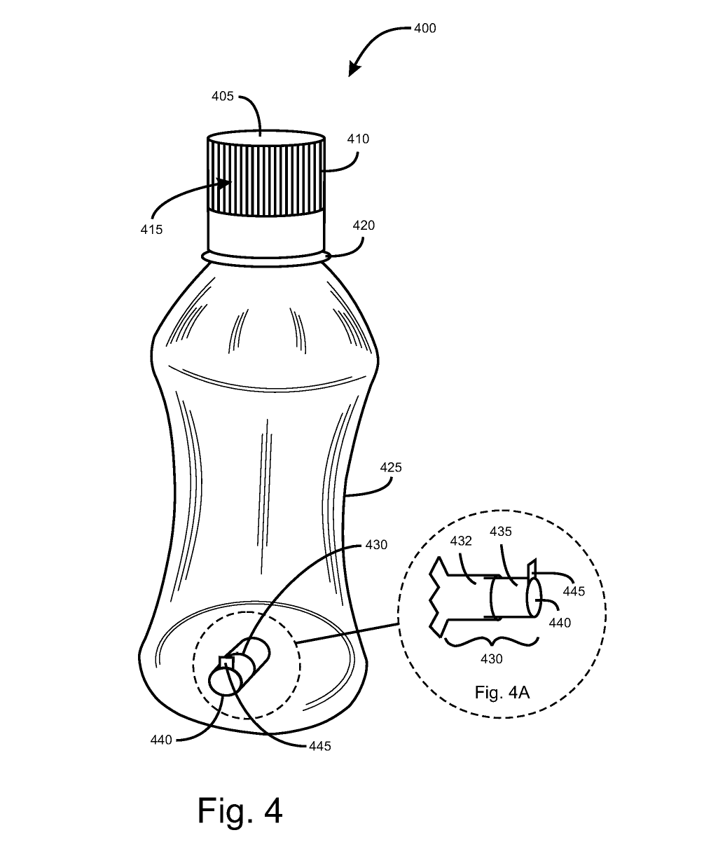

FIG. 4 illustrates an exemplary water bottle with a collapsible spout in accordance with another aspect of the disclosure. Water bottle 400 shares some characteristics of water bottle 300 previously discussed. The first port 405 (hidden), located at the top of water bottle 400 is capped by a screw cap 410 with vertical ribs 415. First port 405 is a bottle opening located under screw cap 410. Below screw cap 410 is a unitary plastic ring 420 forming a collar around the neck of water bottle 400. The unitary plastic ring 420 may also be weakly coupled to the screw cap 410 to provide an anti-tampering indicator. The method of opening and closing first port 405 was discussed in detail for water bottle 300. The main body 425 of water bottle 400 is also substantially similar to water bottle 300. The main body 425 may be slight concave to permit easier grasping and handling. The primary method of drinking from water bottle 400 is to unscrew screw cap 410 and tilt back the water bottle until liquid pours forth from first port 405. As with other exemplary water bottles, liquid may also be dispensed via the secondary means of fluid flow.

Water bottle 400 differs from water bottle 300 in the structure of the secondary means of fluid flow. The secondary means of fluid flow for water bottle 400 includes a collapsible spout 430. Collapsible spout 430 further comprises at least two telescoping members 432 and 435 (shown in FIG. 4A). Collapsible spout 430 also includes foil seal 440 with foil seal tab 445. Telescoping members 432 and 435 collapse down into a shorter tube length to keep the overall length of collapsible spout 430 to a minimum. A shorter spout length may be advantageous when water bottle 400 is transported in a bag or backpack, or when shipped with several other similar water bottles. The collapsible spout 430 may save packaging space by collapsing down to a shorter barrel length.

Foil seal 440, seals the distal end of collapsible water spout 430. A foil seal tab 445 is attached to foil seal 440 as a handle for peeling off foil seal 440 from collapsible spout 430. Foil seal 440 may adhere to collapsible spout 430 by a light yet water resistant adhesive that permits easy removal of foil seal 440 while at the same time keeping the foil seal from accidently falling off. The adhesive used may be a relatively weak adhesive such as those found sealing food packages. The adhesive may also be selected for its nontoxic properties in case the adhesive contacts the liquid contents of water bottle 400.

Collapsible spout 430 may also be used as the water dispensing port. Collapsible spout 430 may provide a secondary means of fluid flow when a high flow rate is needed for rapid hydration. Liquid may be “shotgunned” as described above by drinking from collapsible spout 430 while first port 405 is open. In this alternative method, water bottle 400 is held in an upright position as illustrated in FIG. 4. Collapsible spout 430 is extended outward from the water bottle 400. The foil seal 440 includes a foil seal tab 445 to facilitate rapid removal from water bottle 400. In FIG. 4, foil seal tab 445 is shown at the top of foil seal 440 but may be placed on any of the four sides (top, bottom, left and right) of foil seal 440. Foil seal tab 445 is pulled away from water bottle 400 resulting in removal of foil seal 440. The opened collapsible spout 430 may be placed in the mouth or may be left to drain into another container. Screw cap 410 may be removed to open first port 405, accelerating the liquid flow rate out the collapsible spout 425 e.g. “shotgunning” the liquid.

Foil seal 440 may be attached to water bottle 400 by an adhesive. Preferably, the adhesive is not water soluble; otherwise condensation may cause accidental removal of the foil seal 440. For health reasons, the adhesive is preferably non-toxic.

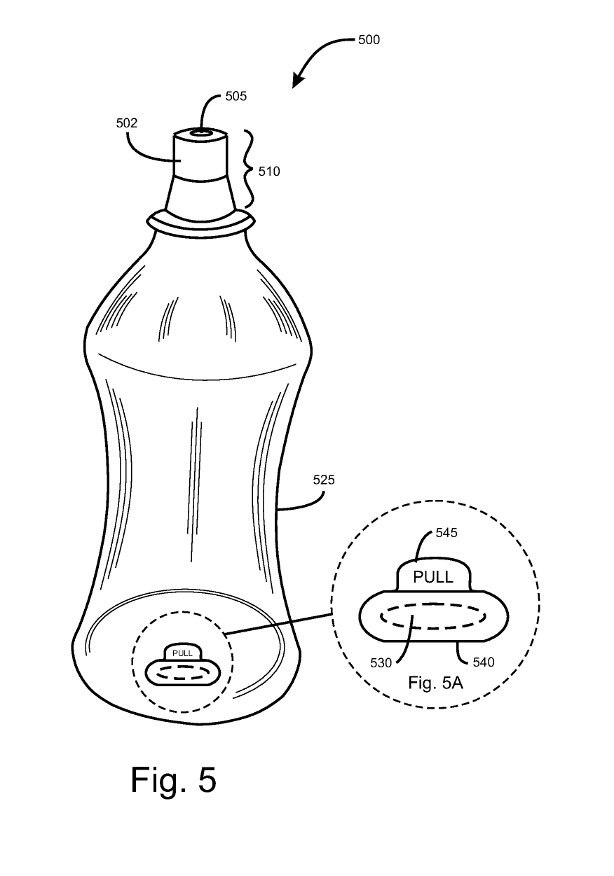

FIG. 5 illustrates another exemplary water bottle with a secondary means of fluid flow sealed by a foil seal in accordance with another aspect of the disclosure.

The top of the water bottle 500 shown in FIG. 5 is capped with a sport cap 510 similar to sport caps of previous embodiments. Sport cap 510 includes a slideably coupled top 502 with a first port 505. Sport cap 510 is shown without a hygienic shield, however, like the embodiment discussed previously, a hygienic shield may be friction fitted to sport cap 510.

Water bottle 500 has a contoured body shape much like previous embodiments. The dumbbell shaped body of water bottle 500 may be advantageous during physical activity. The skinnier middle region may be grasped and held more securely with one hand.

The structure of the secondary means of fluid flow also differs from previous embodiments. A secondary port 530 is molded or formed directly into the side of water bottle 500 near the bottom of the bottle. In FIG. 5, the secondary port 530 is depicted as an oval shaped opening but any shape may be substituted without changing the inventive concept. The secondary port 530 may be sealed by a foil seal 540 with pull tab 545. Foil seal 540 may be affixed to water bottle 500 by a thin layer of non-toxic, water resistant adhesive. Preferably the adhesive is sufficiently strong enough to hold foil seal 540 in place yet still allow foil seal 540 to be peeled off when use of the secondary means of fluid flow is desired.

Pull tab 545 attached to the top of foil seal 540 provides a handle for peeling off foil seal 540 from secondary port 530. In FIG. 5 pull tab 545 is shown at the top of foil seal 540 but may be placed on any of the four sides (top, bottom, left and right) of foil seal 540.

As further support for the embodiments described herein, attached hereto as Appendix I are photographs of several exemplary embodiments of the invention. The photographs may show details not captured in the drawings due to the drawing limitations for line width and shading.

### CONCLUSION

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by the claims that follow below.

What is claimed is:

1. A water bottle, comprising:
a housing adapted to contain a liquid;
a first port, the first port adapted to dispense the liquid;
a first cap removably fastened to the first port, the first cap adapted to seal the first port;
a second port, the second port adapted to dispense a greater fluid flow of liquid than the first port; and
a second cap removably coupled to the second port, the second cap adapted to seal the second port.

2. The water bottle of claim 1, wherein the first cap is a threaded screw cap.

3. The water bottle of claim 1, wherein the second cap is a disposable plastic cap, scored to break and unseal the second port.

4. The water bottle of claim 1, wherein the second cap is a plastic plug.

5. The water bottle of claim 1, wherein the second port is a collapsible spout.

6. The water bottle of claim 1, wherein the bottle is made of a BEP and DEHP free PET plastic.

7. The water bottle of claim 1, wherein the bottle is made of aluminum.

8. A water bottle, comprising:
a bottle adapted to contain a liquid;
a first opening at the top of the bottle, sealed by a sport cap removeably coupled to the bottle, the sport cap adapted to dispense the liquid; and
a second opening at the bottom of the bottle, sealed by a disposable cap removably coupled to the bottle.

9. The water bottle of claim 8, wherein the sport cap is removeably coupled to the bottle by threads formed on the bottle.

10. The water bottle of claim 8, wherein the disposable plastic cap is scored to break off at the score mark and unseal the second opening.

11. The water bottle of claim 8, wherein the sport cap is covered by a hygienic shield friction fitted to the sport cap.

12. The water bottle of claim 8, wherein the bottle is made of a BEP and DEHP free PET plastic.

13. The water bottle of claim 8, wherein the bottle is made of aluminum.

14. A method of dispensing a liquid from a water bottle, the method comprising;
holding the water bottle upright;
opening a second port of the water bottle, located at the bottom of the water bottle;
opening a first port of the water bottle, located at the top of the water bottle; and
applying suction to the second port.

15. The method of claim 14, wherein opening a second port of the water bottle further comprises breaking off a scored portion of a disposable cap.

16. The method of claim 14, wherein opening a first port of the water bottle further comprises, pulling up on a nipple of a sport cap.

17. The method of claim 14, wherein the suction applied to the second port is by mouth.

18. The method of claim 14, further comprising, squeezing the water bottle to increase fluid flow.
